(19) United States
(12) Patent Application Publication
(10) Pub. No.: US 2026/0266312 A1
(43) Pub. Date: Sep. 10, 2026

(54) FAN MODULE AND TERMINAL DEVICE

(71) Applicant: Fulian Precision Electronics (Tianjin) Co., LTD., Tianjin (CN)

(72) Inventor: YEN-LU CHENG, New Taipei (TW)

(21) Appl. No.: 19/189,535

(22) Filed: Apr. 25, 2025

(30) Foreign Application Priority Data
Mar. 6, 2025 (CN) 202510262563.6

(51) Int. Cl. F04D 29/64; F16M 13/02

(52) U.S. Cl. CPC F04D 29/646; F16M 13/02

(57) ABSTRACT

A fan module includes a base, a fan, a fixing plate, and a rotating mechanism. The fan is disposed on the base. The fan includes a main body and an extending portion. The extending portion is connected to the main body and extends along a radial direction of the main body. The fixing plate is fixed on the base. The rotating mechanism is rotatably disposed on the fixing plate and can switch between a first position and a second position when the rotating mechanism rotates relative to the fixing plate. When the rotating mechanism is in the first position, the rotating mechanism limits a position of the fan; when the rotating mechanism rotates to the second position, the rotating mechanism releases the fan. The present disclosure further provides a terminal device.

### FIELD

The subject matter herein generally relates to heat dissipation technologies, and more particularly, to a fan module and a terminal device.

### BACKGROUND

Cold cabinet includes a cabinet and a fan module. The cabinet generates heat during operation, and the fan module can dissipate heat to maintain stable operation of the cold cabinet. The fan module is typically fixed to the cabinet and difficult to disassembled from the cabinet, which is not conducive to the maintenance or replacement of the fan module maintenance. Therefore, there is a room for improvement in the art.

### BRIEF DESCRIPTION OF THE DRAWINGS

Implementations of the present technology will now be described, by way of example only, with reference to the attached figures.

FIG. 1 is a diagrammatic view of a terminal device according to an embodiment of the present disclosure.

FIG. 2 is a diagrammatic view of the terminal device of FIG. 1 in another state.

FIG. 3 is a diagrammatic view of the fan module of FIG. 1 when the rotating mechanism is in a first position.

FIG. 4 is a diagrammatic view of a rotating mechanism and a fixing plate of the rotating mechanism when the rotating mechanism is in the first position.

FIG. 5 is a diagrammatic view of the fan module during a transition of the rotating mechanism from the first position to a second position.

FIG. 6 is a diagrammatic view of the rotating mechanism and the fixing plate during the transition from the first position to the second position.

FIG. 7 is a diagrammatic view of the fan module when the rotating mechanism is in the second position.

FIG. 8 is a diagrammatic view of the rotating mechanism and the fixing plate when the rotating mechanism is in the second position.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

Some embodiments of the present disclosure will be described in detail with reference to the drawings. If no conflict, the following embodiments and features in the embodiments can be combined with each other.

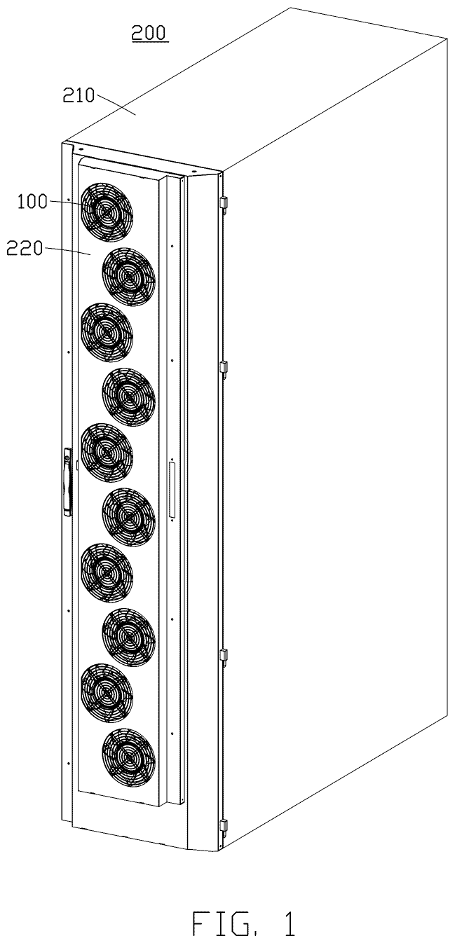

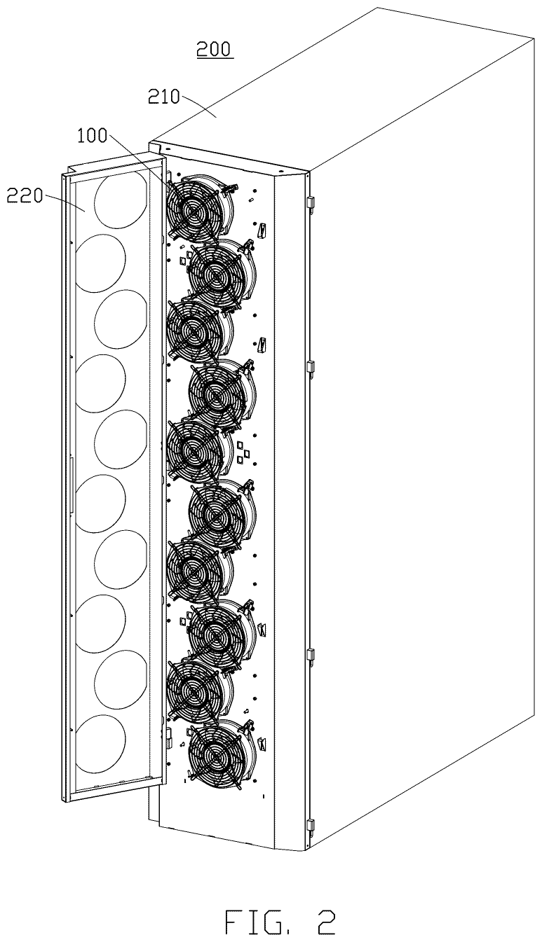

Referring to FIGS. 1 and 2, a terminal device 200 is provided according to an embodiment of the present disclosure. The terminal device 200 is a product that requires a fan 20 to dissipate heat therein. The terminal device 200 may be a cold cabinet, a distribution box, a medical imaging equipment, etc. In the embodiment, the terminal device 200 is a cold cabinet.

The terminal device 200 includes a cabinet 210, a housing 220, and a fan module 100. The housing 220 is rotatably disposed on the cabinet 210 (referring to FIG. 2). The fan module 100 is disposed in an accommodating space formed by the housing 220 and the cabinet 210. The cabinet 210 generates heat during operation, and the fan module 100 dissipates the heat generated by the cabinet 210.

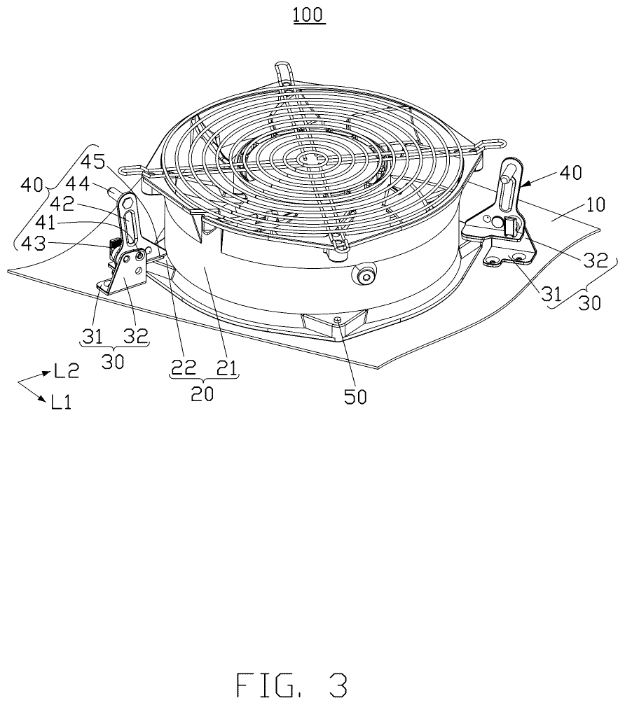

Referring to FIGS. 3 to 8, the fan module 100 may include a base 10, a fan 20, a fixing plate 30, and a rotating mechanism 40. The base 10 is substantially plate-shaped. The fan 20 is detachably disposed on the base 10. The fixing plate 30 is fixed on the base 10. The rotating mechanism 40 is rotatably disposed on the fixing plate 30. The rotating mechanism 40 can limit the position of the fan 20 and enables assembly and disassembly of the fan 20 without additional tools.

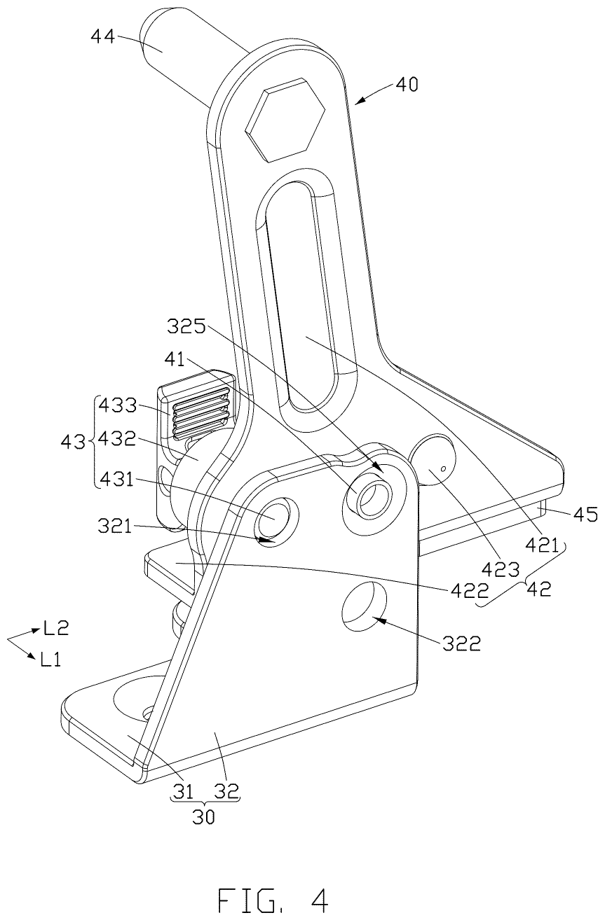

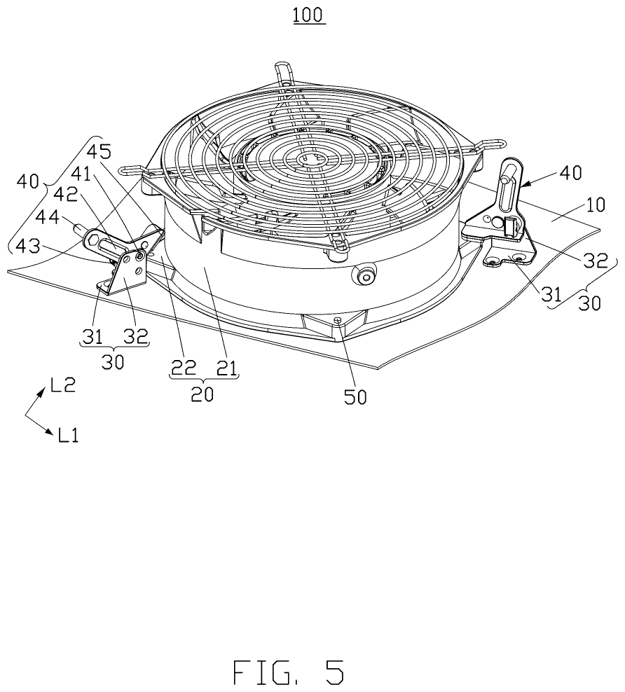

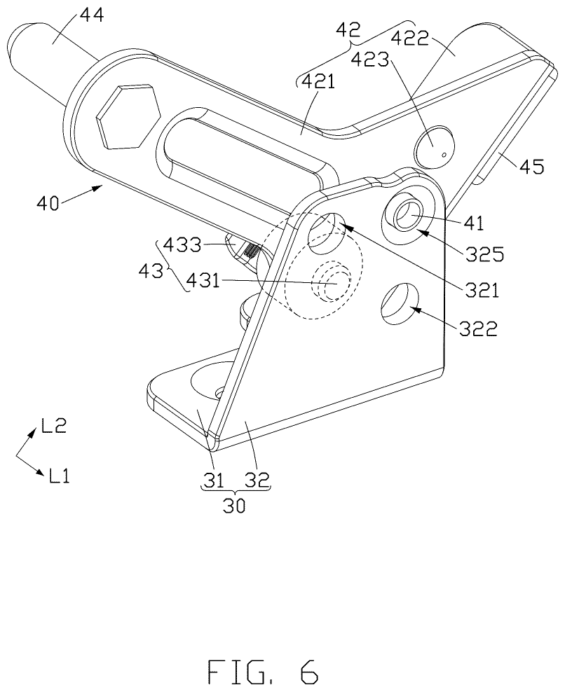

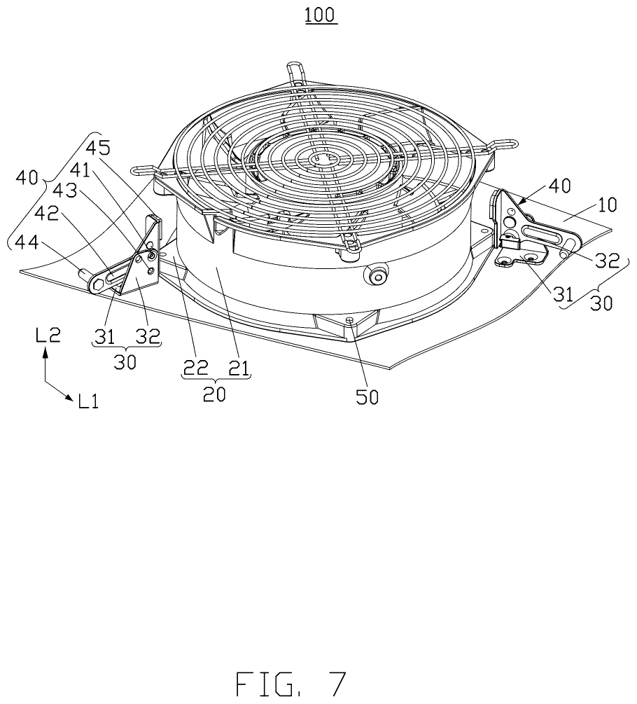

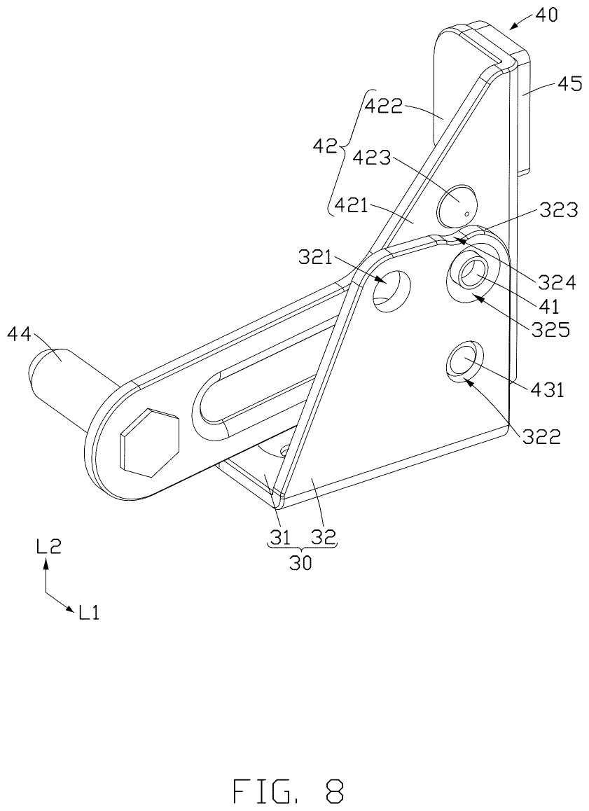

When the rotating mechanism 40 is in a first position, the rotating mechanism 40 limits the position of the fan 20. When the rotating mechanism 40 rotates relative to the fixing plate 30 to a second position, the rotating mechanism 40 releases the fan 20. FIG. 3 is a diagrammatic view of the fan module 100 when the rotating mechanism 40 is in the first position. FIG. 4 is a diagrammatic view of the rotating mechanism 40 and the fixing plate 30 when the rotating mechanism 40 is in the first position. FIG. 5 is a diagrammatic view of the fan module 100 during the transition of the rotating mechanism 40 from the first position to the second position. FIG. 6 is a diagrammatic view of the rotating mechanism 40 and the fixing plate 30 during the transition from the first position to the second position. FIG. 7 is a diagrammatic view of the fan module 100 when the rotating mechanism 40 is in the second position. FIG. 8 is a diagrammatic view of the rotating mechanism 40 and the fixing plate 30 when the rotating mechanism 40 is in the second position.

In the embodiment, the fan module 100 includes a plurality of fans 20, a plurality of fixing plates 30, and a plurality of rotating mechanisms 40. Each fan 20 may correspond to one or more rotating mechanisms 40, that is, at least one rotating mechanism 40 can limit the position of one fan 20, and the number of fixing plates 30 is equal to the number of rotating mechanisms 40. In the embodiment shown in FIGS. 3, 5, and 7, which illustrate one fan 20 and two rotating mechanisms 40 as an example. The plurality of fans 20 are disposed on the same surface of the base 10.

The fan 20 includes a main body 21 and at least one extending portion 22. The extending portion 22 is connected to the main body 21 and extends along a radial direction of the main body 21. In the embodiment, the fan 20 includes four extending portions 22, which are spaced apart from each other and disposed around the main body 21. In other embodiments, the number of extending portion(s) 22 may be one or more.

The fixing plate 30 may include a first fixing portion 31 and a second fixing portion 32 connected to the first fixing portion 31. The first fixing portion 31 and a second fixing portion 32 cooperate form a substantially L-shaped structure. The first fixing portion 31 is fixed on the base 10, and the second fixing portion 32 extends from one side of the first fixing portion 31 in a direction away from the base 10. The second fixing portion 32 is substantially perpendicular to the base 10. The second fixing portion 32 is used to assemble the rotating mechanism 40.

A first center hole 325 is defined on the second fixing portion 32, and a second center hole (not shown) is defined on the rotating mechanism 40. The rotating mechanism 40 may include a rotating shaft 41. The rotating shaft 41 extends through the first center hole 325 of the second fixing portion 32 and the second center hole of the rotating mechanism 40. The rotating mechanism 40 can rotate relative to the fixing plate 30 around the rotating shaft 41. For ease of illustration, the rotating mechanism 40 rotate in a first direction defined as L1.

A first positioning hole 321 and a second positioning hole 322 are defined on the second fixing portion 32. The rotating mechanism 40 includes a positioning pin 431. When the rotating mechanism 40 is in the first position, the positioning pin 431 extends through the first positioning hole 321; when the rotating mechanism 40 is in the second position, the positioning pin 431 extends through the second positioning hole 322. Since the positioning pin 431 moves in a circular motion relative to the first center hole 325, a distance from the first positioning hole 321 to the first center hole 325 is equal to a distance from the second positioning hole 322 to the second center hole 325.

The rotating mechanism 40 may include a baffle portion 42 and a locking assembly 43. The locking assembly 43 is assembled on the baffle portion 42. The locking assembly 43 serves a locking function. When the locking assembly 43 is in a locked state, the rotating mechanism 40 is fixed relative to the fixing plate 30. When the locking assembly 43 is in an unlocked state, the rotating mechanism 40 can rotate relative to the fixing plate 30.

The baffle portion 42 includes a first baffle portion 421 and a second baffle portion 422 connected to the first baffle portion 421. The first baffle portion 421 and the second baffle portion 422 cooperate form a substantially L-shaped structure. The first baffle portion 421 is fixed on the second fixing portion 32. The second baffle portion 422 is spaced apart from the first fixing portion 31. The second baffle portion 422 can limit the position of the extending portion 22. A portion of the second baffle portion 422 extends toward the fan 20 relative to the second fixing portion 32, allowing the second baffle portion 422 to limit the position of the extending portion 22.

The locking assembly 43 includes a positioning pin 431, a sleeve 432, and a first handle 433. The sleeve 432 is fixed on a side of the first baffle portion 421 away from the second fixing portion 32. The positioning pin 431 telescopically extends through the sleeve 432 and the first baffle portion 421. The first handle 433 is disposed on a side of the sleeve 432 away from the first baffle portion 421. One end of the first handle 433 abuts against the sleeve 432. The first handle 433 is rotatably connected to the end of the positioning pin 431 away from the second fixing portion 32. The first handle 433 can rotate in a second direction L2 with a contact point between the first handle 433 and the sleeve 432 serving as a pivot point, where the second direction L2 is perpendicular to the first direction L1. The rotation of the first handle 433 drives the positioning pin 431 to telescopically move relative to the first baffle portion 421 along the first direction L1. When the positioning pin 431 protrudes from the side of the first baffle portion 421 away from the sleeve 432, the positioning pin 431 can be disposed in either the first positioning hole 321 or the second positioning hole 322, and the locking assembly 43 is in the locked state. When the positioning pin 431 does not protrude from the side of the first baffle portion 421 away from the sleeve 432, the locking assembly 43 is in the unlocked state.

The rotating mechanism 40 may further include a second handle 44. The second handle 44 is fixed on the end of the first baffle portion 421 away from the second baffle portion 422. A force can be applied to the second handle 44 to facilitate the rotation of the baffle portion 42 around the first direction L1.

The interaction relationships between components are explained through the specific disassembly process below.

Referring to FIGS. 3 and 4, when the fan 20 is assembled on the base 10, the positioning pin 431 extends through the first baffle portion 421 and is disposed in the first positioning hole 321. The second baffle portion 422 is disposed on the side of the extending portion 22 away from the base 10 to limit the fan 20. At this time, the rotating mechanism 40 is in the first position and in the locked state.

Referring to FIGS. 5 and 6, when the fan 20 needs to be disassembled, a force is applied to the first handle 433, causing the first handle 433 to rotate in the second direction L2. During the rotation of the first handle 433, the first handle 433 drives the positioning pin 431 to move away from the second fixing portion 32 along the first direction L1 relative to the first baffle portion 421, causing the positioning pin 431 to move away from the first positioning hole 321, releasing the locked state of the rotating mechanism 40. Then a force is applied to the second handle 44, causing the second handle 44 to rotate in the first direction L1. During the rotation of the second handle 44, the baffle portion 42 rotates synchronously with the second handle 44, and the positioning pin 431 rotates synchronously with the baffle portion 42.

Referring to FIGS. 7 and 8, when the positioning pin 431 rotates to align with the second positioning hole 322, a force is again applied to the first handle 433, causing the first handle 433 to rotate in the second direction L2. During the rotation of the first handle 433, the first handle 433 drives the positioning pin 431 to move toward the second fixing portion 32 along the first direction L1 relative to the first baffle portion 421. The positioning pin 431 extends through the second positioning hole 322, causing the rotating mechanism 40 in a locked state. At this time, the second baffle portion 422 releases the extending portion 22, allowing the fan 20 to be disassembled.

When the fan 20 needs to be assembled on the base 10, the assembly can be achieved by following the steps in reverse order of the disassemble process.

The fan module 100 provided in the embodiment enables the disassembly of the fan 20 simply by first releasing the locked state of the rotating mechanism 40 and then rotating the rotating mechanism 40 to release the fan 20. For the assembly of the fan 20, after the fan 20 is placed in a predetermined position, the rotating mechanism 40 is rotated to limit the position of the fan 20, then the rotating mechanism 40 is locked, thus achieving the assembly and disassembly of the fan 20 without additional tools.

The baffle portion 42 may further include a protrusion 423. The protrusion 423 is disposed on the surface of the first baffle portion 421 facing the second fixing portion 32. The second fixing portion 32 includes a top portion 323. The top portion 323 is an end of the second fixing portion 32 away from the base 10. During the transition of the rotating mechanism 40 from the first position to the second position, when the positioning pin 431 aligns with the second positioning hole 322, the top portion 323 can support the protrusion 423, thereby facilitating the application of the force to the first handle 433 to allow the positioning pin 431 to extend through the second positioning hole 322.

A groove 324 is defined on the top portion 323. The groove 324 can accommodate the protrusion 423. When the protrusion 423 rotates with the baffle portion 42 into the groove 324, the groove 324 serves as a stop to limit the position of the protrusion 432.

The fan module 100 may further include a cushion 45 disposed on the surface of the second baffle portion 422 away from the first baffle portion 421. The cushion 45 can be elastically contact the extending portion 22.

A through hole (not labeled) is defined on each extending portion 22. The fan module 100 may further include a pin 50 detachably disposed on the base 10. The pin 50 can extend through the through hole, which may pre-position the fan 20 during the assembly process.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A fan module comprising:
a base;
a fan disposed on the base, the fan comprising a main body and an extending portion, the extending portion connected to the main body and extending along a radial direction of the main body;
a fixing plate fixed on the base; and
a rotating mechanism rotatably disposed on the fixing plate and configured to switch between a first position and a second position when the rotating mechanism rotates relative to the fixing plate,
wherein when the rotating mechanism is in the first position, the rotating mechanism limits a position of the fan; when the rotating mechanism is rotated to the second position, the rotating mechanism releases the fan.

2. The fan module of claim 1, wherein the fixing plate defines a first positioning hole and a second positioning hole, the rotating mechanism comprises a positioning pin; when the rotating mechanism is in the first position, the positioning pin is disposed in the first positioning hole; when the rotating mechanism is in the second position, the positioning pin is disposed in the second positioning hole.

3. The fan module of claim 2, wherein the rotating mechanism comprises:
a baffle portion rotatably disposed on the fixing plate; and
a locking assembly comprising the positioning pin, a sleeve, and a first handle, the sleeve is fixed on a side of the baffle portion away from the fixing plate, the positioning pin telescopically extends through the sleeve and the baffle portion, and the first handle is rotatably connected to an end of the positioning pin away from the fixing plate,
wherein the first handle is configured to drive the positioning pin to telescopically move relative to the baffle portion when the first handle rotates relative to the positioning pin.

4. The fan module of claim 3, wherein the baffle portion is configured to rotate in a first direction, the first handle is configured to rotate in a second direction, and the second direction is perpendicular to the first direction.

5. The fan module of claim 3, wherein the baffle portion comprises a first baffle portion and a protrusion, the first baffle portion is connected to the fixing plate, the protrusion is disposed on a surface of the first baffle portion facing the fixing plate; the fixing plate comprises a top portion, the top portion is an end of the fixing plate away from the base, and the top portion is configured to support the protrusion.

6. The fan module of claim 5, wherein the top portion defines a groove, and the groove is configured to accommodate the protrusion.

7. The fan module of claim 5, wherein the baffle portion further comprises a second baffle portion, the second baffle portion is connected to the first baffle portion, the second baffle portion is configured to limit the position of the fan.

8. The fan module of claim 5, further comprising a cushion, wherein the cushion is disposed on a surface of the second baffle portion away from the first baffle portion.

9. The fan module of claim 3, wherein the rotating mechanism further comprises a second handle, and the rotating mechanism is fixed to the baffle portion.

10. The fan module of claim 1, wherein the rotating mechanism further comprises a rotating shaft, the rotating shaft extends through the fixing plate and the rotating mechanism, and the rotating mechanism is configured to rotate relative to the fixing plate around the rotating shaft.

11. A terminal device comprising a fan module, the fan module comprising:
a base;
a fan disposed on the base, the fan comprising a main body and an extending portion, the extending portion connected to the main body and extending along a radial direction of the main body;
a fixing plate fixed on the base; and
a rotating mechanism rotatably disposed on the fixing plate and configured to switch between a first position and a second position when the rotating mechanism rotates relative to the fixing plate,
wherein when the rotating mechanism is in the first position, the rotating mechanism limits a position of the fan; when the rotating mechanism is rotated to the second position, the rotating mechanism releases the fan.

12. The terminal device of claim 11, wherein the fixing plate defines a first positioning hole and a second positioning hole, the rotating mechanism comprises a positioning pin; when the rotating mechanism is in the first position, the positioning pin is disposed in the first positioning hole; when the rotating mechanism is in the second position, the positioning pin is disposed in the second positioning hole.

13. The terminal device of claim 12, wherein the rotating mechanism comprises:
a baffle portion rotatably disposed on the fixing plate; and
a locking assembly comprising the positioning pin, a sleeve, and a first handle, the sleeve is fixed on a side of the baffle portion away from the fixing plate, the positioning pin telescopically extends through the sleeve and the baffle portion, and the first handle is rotatably connected to an end of the positioning pin away from the fixing plate,
wherein the first handle is configured to drive the positioning pin to telescopically move relative to the baffle portion when the first handle rotates relative to the positioning pin.

14. The terminal device of claim 13, wherein the baffle portion is configured to rotate in a first direction, the first handle is configured to rotate in a second direction, and the second direction is perpendicular to the first direction.

15. The terminal device of claim 13, wherein the baffle portion comprises a first baffle portion and a protrusion, the first baffle portion is connected to the fixing plate, the protrusion is disposed on a surface of the first baffle portion facing the fixing plate; the fixing plate comprises a top portion, the top portion is an end of the fixing plate away from the base, and the top portion is configured to support the protrusion.

16. The terminal device of claim 15, wherein the top portion defines a groove, and the groove is configured to accommodate the protrusion.

17. The terminal device of claim 15, wherein the baffle portion further comprises a second baffle portion, the second baffle portion is connected to the first baffle portion, the second baffle portion is configured to limit the position of the fan.

18. The terminal device of claim 15, wherein the fan module further comprises a cushion, the cushion is disposed on a surface of the second baffle portion away from the first baffle portion.

19. The terminal device of claim 13, wherein the rotating mechanism further comprises a second handle, and the rotating mechanism is fixed to the baffle portion.

20. The terminal device of claim 11, wherein the rotating mechanism further comprises a rotating shaft, the rotating shaft extends through the fixing plate and the rotating mechanism, and the rotating mechanism is configured to rotate relative to the fixing plate around the rotating shaft.
